(19) United States
(12) Patent Application Publication
(10) Pub. No.: US 2009/0251677 A1
(43) Pub. Date: Oct. 8, 2009

(54) ILLUMINATING OPTICAL UNIT AND PROJECTION EXPOSURE APPARATUS FOR MICROLITHOGRAPHY

(75) Inventors: Martin Endres, Koenigsbronn (DE); Jens Ossmann, Aalen (DE); Ralf Stuetzle, Aalen (DE)

Correspondence Address: FISH & RICHARDSON PC, P.O. BOX 1022, MINNEAPOLIS, MN, 55440-1022, US

(73) Assignee: CARL ZEISS SMT AG, Oberkochen (DE)

(21) Appl. No.: 12/473,137

(22) Filed: May 27, 2009

Related U.S. Application Data
(63) Continuation of application No. PCT/EP2007/010234, filed on Nov. 24, 2007.
(60) Provisional application No. 60/874,770, filed on Dec. 14, 2006.

(30) Foreign Application Priority Data
Dec. 14, 2006 (DE) 10 2006 059 024.4

(51) Int. Cl. G03B 27/72

(52) U.S. Cl. 355/71

(57) ABSTRACT

A projection exposure apparatus for microlithography has an illumination system with an EUV light source and an illumination optical unit to expose an object field in an object plane. A projection optical unit images the object field into an image field in an image plane. A pupil facet mirror in a plane of the illumination optical unit that coincides with a pupil plane of the projection optical unit or that is optically conjugate with respect thereto has a plurality of individual facets on which illumination light can impinge. A correction diaphragm is in or adjacent to a pupil plane of the projection optical unit or in a conjugate plane with respect thereto. The correction diaphragm screens the illumination of the entrance pupil of the projection optical unit so that at least some source images assigned to the individual facets of the pupil facet mirror in the entrance pupil of the projection optical unit are partly shaded by one and the same diaphragm edge. The form of the diaphragm edge is predefined for the partial shading of the source images assigned to the pupil facets in the entrance pupil of the projection optical unit for the correction of the telecentricity and the ellipticity of the illumination.

### CROSS-REFERENCE TO RELATED APPLICATIONS

This application is a continuation of, and claims benefit under 35 USC 120 to, international application PCT/EP2007/010234, filed Nov. 24, 2007, which claims benefit of German Application No. 10 2006 059 024.4, filed Dec. 14, 2006 and U.S. Ser. No. 60/874,770, filed Dec. 14, 2006. International application PCT/EP2007/010234 is hereby incorporated by reference in its entirety.

### FIELD

The disclosure generally relates to a projection exposure apparatus for microlithography, an illumination optical unit for such a projection exposure apparatus, a method for operating such a projection exposure apparatus, a method for producing a microstructured component, and a microstructured component produced by the method.

### BACKGROUND

Projection exposure apparatuses for microlithography are known. Such projection exposure apparatuses are generally designed precisely for demanding projection exposure tasks. Consideration is often given to illumination parameters, such as distortion, telecentricity and ellipticity.

### SUMMARY

In some embodiments, the disclosure provides a projection exposure apparatus having improved illumination parameters thereof, such as improved distortion, telecentricity and ellipticity.

It has been recognized that illumination parameters of the illumination optical unit, such as a distortion effect of the imaging optical group upstream of the object plane, can be influenced by way of the diaphragm edge of a correction diaphragm. This can be utilized to optimize these parameters in such a way that the deviation of these parameters from predefined values is minimized. The form of the diaphragm edge can therefore be predefined, such as for the precompensation of a distortion aberration caused by the imaging optical assembly upstream of the object plane. It is possible to adapt a shading of a pupil facet mirror of the illumination optical unit to different geometries of the imaging optical assembly upstream of the object plane and to different illumination settings. By way of example, an elliptical edge contour of the diaphragm edge of the correction diaphragm can have the consequence that the combination of a correspondingly elliptically preshaped beam of rays with the distorting effect of the downstream imaging optical assembly upstream of the object plane leads to a desirably rotationally symmetrical illumination angle distribution of the illumination of the field points of the object field.

In some embodiments, a pupil facet mirror can help enable a defined predefinition of an illumination device distribution over the object field.

In certain embodiments, a shading can permit a fine predefinition of the illumination parameters of the projection exposure apparatus without the diaphragm edge in this case having to be adapted to the form of individual facets. A diaphragm edge of this type can be produced with comparatively little outlay.

The distortion-correcting properties of the correction diaphragm can be manifested particularly well with certain configurations of the illumination optical unit with a field facet mirror.

Arcuate field facets can be used in connection with an arcuate object field to be illuminated. The arc field is often produced by a mirror for grazing incidence (grazing incidence mirror), which is part of the imaging optical assembly upstream of the object plane. The correction diaphragm can help ensure that a distorting effect caused by the mirror for grazing incidence is compensated for.

In certain embodiments, a projection exposure apparatus has a correction diaphragm together with the pupil facet mirror configured as a structural unit. This structural unit can include a correction diaphragm changeable holder which is connected to the pupil facet mirror. This can help make it possible to use different correction diaphragms with one and the same pupil facet mirror. The changeable holder can alternatively also be a component independent of the pupil facet mirror.

In some embodiments, a correction section can be a particularly simple configuration of a correction diaphragm. The uncorrected circumferential contour of a diaphragm can be defined by rays which emerge from the diaphragm edge of the uncorrected diaphragm and run through the center of a field, that is to say e.g. of the object or image field, of the illumination or projection optical unit. Insofar as these rays in the angle space, that is to say insofar as the marginal rays of the illumination angle distribution, can be described by a simple geometrical form, that is to say e.g. an exact circle, a plurality of circles, a square, an ellipse, a trapezoid, a rectangle, a sinusoidal or cosinusoidal form, around the principal ray direction, an as yet uncorrected circumferential contour is present. The correction magnitude by which the circumferential contour of the correction diaphragm deviates from the further, uncorrected circumferential contour lies in the region of a fraction of the diameter of the partly shaded source images. In this case, the correction magnitude can vary between 1% and 90% of the source image diameter. A correction magnitude can be between 10% and 80% (e.g., between 20% and 70%, between 30% and 60%, between 40% and 50%) of the source image diameter.

It has also been recognized that the illumination parameters of telecentricity and ellipticity can be influenced by way of the diaphragm edge of a correction diaphragm. This can be utilized to optimize these parameters in such a way that the deviation of these parameters from predefined values is minimized. The form of the diaphragm edge can therefore be predefined, such as for the correction of the telecentricity and the ellipticity of the illumination of the object field. It is possible to adapt a shading of the pupil facet mirror to different geometries of radiation sources and to different illumination settings. The shading can be effected directly adjacent to the pupil facet mirror, such that individual facets of the pupil facet mirror themselves are shaded. As an alternative, it is possible for the correction diaphragm not to be arranged adjacent to the pupil facet mirror but rather to be arranged in the region of a conjugate pupil plane with respect to the pupil facet mirror. In each of these cases, either some individual facets or some source images assigned to these individual facets are partly shaded by one and the same diaphragm edge.

Demanding requirements made of the illumination parameters of telecentricity and ellipticity can be satisfied with a correction profile.

A predefinition of an uncorrected circumferential contour can constitute a start value for an optimization for configuration of the diaphragm edge profile of the correction diaphragm. A corresponding optimization method can be carried out with readily manageable computational complexity. A stepwise deviation of the circumferential contour of the correction diaphragm from an uncorrected circumferential contour is also possible as an alternative.

An adjustable correction diaphragm can help enable a fine adjustment and hence fine optimization of the illumination parameters of telecentricity and ellipticity.

A correction diaphragm can have a particularly simple construction. A conventional setting with a predefined fill factor is possible with such a diaphragm.

A correction diaphragm can help ensure an annular illumination setting that is corrected with regard to the illumination parameters of telecentricity and ellipticity. Here, too, the form of at least one of the diaphragm edges is predefined for the correction of the telecentricity and the ellipticity of the illumination.

In some embodiments, a corrected dipole, quadrupole or other multipole setting can be produced with a correction diaphragm. Other corrected illumination settings are also possible. In this variant, too, the form of at least one of the diaphragm edges can be predefined for the correction of the telecentricity and the ellipticity of the illumination.

In certain embodiments, a projection exposure apparatus can enable a particularly high resolution and hence the transfer of very fine object structures. The useful radiation of the EUV light or radiation source has a wavelength of, for example, between 10 and 30 nm.

An advantageous component is the correction diaphragm, which can in turn be integrated into a structural unit of the illumination optical unit. In some embodiments, advantages can be achieved using an illumination optical unit in combination with a known projection optical unit.

In some embodiments, the disclosure provides an operating method for a projection exposure apparatus in which it is possible to change between simultaneously telecentricity- and ellipticity-corrected illuminations depending on different EUV radiation sources.

Depending on the desired properties for the light throughput, for example, the projection exposure apparatus can be operated e.g. with different EUV radiation sources or with different collectors. An illumination module comprising both the radiation source and the collector can also be exchanged. Depending on the irradiation source which is used and which is accommodated in the corresponding illumination module, a correction diaphragm adapted thereto is used. The correction diaphragm can also be replaced for predefining different illumination settings in the case of one and the same radiation source. The replacement of the illumination setting therefore also constitutes the exchange of a first illumination geometry for a second illumination geometry.

Via an adaptation or an exchange of a correction element, which is also referred to hereinafter as a uniformity correction element, it is possible to ensure an optimized image field illumination after an exchange of the illumination geometry even in cases where the change of illumination geometry initially has an undesirable influence on the uniformity of the illumination over the image field. The uniformity correction element then ensures that the uniformity over the image field remains within predefined limits. In the design of the correction diaphragm and of the uniformity correction element an iterative process takes place, if appropriate, until telecentricity, ellipticity and uniformity lie within predefined tolerance limits.

A projection exposure apparatus can be used in the production of a microstructured component to provide a higher structure resolution on account of the better controllable illumination parameters of telecentricity and ellipticity by comparison with the prior art.

### BRIEF DESCRIPTION OF THE DRAWINGS

Exemplary embodiments are explained in more detail below with reference to the drawing in which:

FIG. 1 schematically shows a meridional section through a projection exposure apparatus for EUV projection microlithography;

FIG. 2 shows a plan view of a field facet mirror of an illumination optical unit of the projection exposure apparatus according to FIG. 1 on an enlarged scale, with indication of an energy distribution on the surface of the field facet mirror by an EUV radiation source;

FIG. 3 shows a plan view of a pupil facet mirror of the illumination optical unit of the projection exposure apparatus according to FIG. 1 on an enlarged scale, with indication of an energy distribution on the surface of the pupil facet mirror by an EUV radiation source;

FIG. 4 shows a scan-integrated illumination of an entrance pupil in the field center of an object field which is illuminated by the illumination optical unit of the projection exposure apparatus;

FIG. 5 shows the effect of a diaphragm arranged in or adjacent to a pupil plane of the illumination optical unit on the illumination according to FIG. 4;

FIG. 6 shows an energy distribution of a first EUV radiation source of the projection exposure apparatus according to FIG. 1 at an intermediate focus of the illumination optical unit;

FIG. 7 shows the field facet mirror according to FIG. 2, with indication there of an energy distribution on the surface of the field facet mirror by an EUV radiation source according to FIG. 6;

FIG. 8 shows an energy distribution on the pupil facet mirror of the illumination optical unit, produced by an EUV radiation source according to FIG. 6;

FIG. 9 shows the scan-integrated illumination of the entrance pupil in the field center of the object field, produced by an EUV light source according to FIG. 6;

FIG. 10 shows, in an illustration similar to FIG. 5, the effect a diaphragm arranged in or adjacent to a pupil plane of the illumination optical unit on the illumination according to FIG. 9, a profile of an uncorrected diaphragm also being reproduced in addition to a correction diaphragm profile;

FIG. 11 shows a polar coordinate diagram that reproduces the profile of the inner diaphragm edge of the uncorrected diaphragm and of the corrected diaphragm according to FIG. 10;

FIG. 12 shows the dependence of the uniformity versus the position of the object field in the case of an uncorrected and a corrected diaphragm edge profile;

FIG. 13 shows the dependence of the fill factor σ versus the position of the object field in the case of an uncorrected and a corrected diaphragm edge profile;

FIG. 14 shows the dependence of the x-telecentricity versus the position of the object field in the case of an uncorrected and a corrected diaphragm edge profile;

FIG. 15 shows the dependence of the y-telecentricity versus the position of the object field in the case of an uncorrected and a corrected diaphragm edge profile;

FIG. 16 shows the dependence of the ellipticity 0/90 versus the position of the object field in the case of an uncorrected and a corrected diaphragm edge profile;

FIG. 17 shows the dependence of the ellipticity −45/45 versus the position of the object field in the case of an uncorrected and a corrected diaphragm edge profile;

FIG. 18 shows an energy distribution of an EUV radiation source of the projection exposure apparatus according to FIG. 1 at an intermediate focus of the illumination optical unit in the case of an EUV radiation source;

FIG. 19 shows the field facet mirror according to FIG. 2, with indication there of an energy distribution on the surface of the field facet mirror by an EUV radiation source according to FIG. 18;

FIG. 20 shows an energy distribution on the pupil facet mirror of the illumination optical unit, produced by an EUV radiation source according to FIG. 18;

FIG. 21 shows the scan-integrated illumination of the entrance pupil in the field center of the object field, produced by an EUV light source according to FIG. 18;

FIG. 22 shows, in an illustration similar to FIG. 10, the effect of a diaphragm arranged in or adjacent to a pupil plane of the illumination optical unit on the illumination according to FIG. 18;

FIG. 23 shows a polar coordinate diagram that reproduces the profile of the inner diaphragm edge of an uncorrected diaphragm and of a corrected diaphragm according to FIG. 22;

FIG. 24 shows the dependence of the uniformity versus the position of the object field in the case of an uncorrected and a corrected diaphragm edge profile according to FIG. 22;

FIG. 25 shows the dependence of the fill factor versus the position of the object field in the case of an uncorrected and a corrected diaphragm edge profile according to FIG. 22;

FIG. 26 shows the dependence of the x-telecentricity versus the position of the object field in the case of an uncorrected and a corrected diaphragm edge profile according to FIG. 22;

FIG. 27 shows the dependence of the y-telecentricity versus the position of the object field in the case of an uncorrected and a corrected diaphragm edge profile according to FIG. 22;

FIG. 28 shows the dependence of the ellipticity 0/90 versus the position of the object field in the case of an uncorrected and a corrected diaphragm edge profile according to FIG. 22;

FIG. 29 shows the dependence of the ellipticity −45/45 versus the position of the object field in the case of an uncorrected and a corrected diaphragm edge profile according to FIG. 22;

FIG. 30 shows a plan view of a field facet mirror for use in a projection exposure apparatus according to FIG. 1, illuminated with an EUV radiation source in the form of a surface emitter with angle-dependent emission;

FIG. 31 shows, in an illustration similar to FIG. 3, the illumination of a pupil facet mirror with the surface emitter according to FIG. 30;

FIG. 32 shows, in an illustration similar to FIG. 4, the scan-integrated illumination of the entrance pupil in the center of the object field, illuminated with the surface emitter according to FIG. 30;

FIG. 33 shows, in an illustration similar to FIG. 10, the effect of a diaphragm arranged in or adjacent to a pupil plane of the illumination optical unit on the illumination according to FIG. 30;

FIG. 34 shows a polar coordinate diagram which reproduces the profile of the inner diaphragm edge of the uncorrected diaphragm and of the corrected diaphragm according to FIG. 33;

FIG. 35 shows the dependence of the uniformity versus the position of the object field in the case of an uncorrected and a corrected diaphragm edge profile, illuminated with the surface emitter according to FIG. 30;

FIG. 36 shows the dependence of the fill factor versus the position of the object field in the case of an uncorrected and a corrected diaphragm edge profile, illuminated with the surface emitter according to FIG. 30;

FIG. 37 shows the dependence of the x-telecentricity versus the position of the object field in the case of an uncorrected and a corrected diaphragm edge profile, illuminated with the surface emitter according to FIG. 30;

FIG. 38 shows the dependence of the y-telecentricity versus the position of the object field in the case of an uncorrected and a corrected diaphragm edge profile, illuminated with the surface emitter according to FIG. 30;

FIG. 39 shows the dependence of the ellipticity 0/90 versus the position of the object field in the case of an uncorrected and a corrected diaphragm edge profile, illuminated with the surface emitter according to FIG. 30;

FIG. 40 shows the dependence of the ellipticity −45/45 versus the position of the object field in the case of an uncorrected and a corrected diaphragm edge profile, illuminated with the surface emitter according to FIG. 30;

FIG. 41 shows, in an illustration similar to FIG. 10, an uncorrected and a corrected inner and outer diaphragm edge of a ring correction diaphragm and its effect of a pupil facet mirror for use in a projection exposure apparatus according to FIG. 1;

FIG. 42 shows a polar coordinate diagram which reproduces the profile of the inner diaphragm edge of the uncorrected diaphragm and of the corrected diaphragm according to FIG. 41;

FIG. 43 shows the dependence of the x-telecentricity versus the position of the object field in the case of an uncorrected and a corrected diaphragm edge profile, when using the uncorrected and respectively the corrected correction diaphragm according to FIG. 41;

FIG. 44 shows the dependence of the y-telecentricity versus the position of the object field in the case of an uncorrected and a corrected diaphragm edge profile, when using the uncorrected and respectively the corrected correction diaphragm according to FIG. 41;

FIG. 45 shows the dependence of the ellipticity 0/90 versus the position of the object field in the case of an uncorrected and a corrected diaphragm edge profile, when using the uncorrected and respectively the corrected correction diaphragm according to FIG. 41;

FIG. 46 shows the dependence of the ellipticity −45/45 versus the position of the object field in the case of an uncorrected and a corrected diaphragm edge profile, when using the uncorrected and respectively the corrected correction diaphragm according to FIG. 41;

FIG. 47 shows, in an illustration similar to FIG. 1, a projection exposure apparatus for EUV projection microlithography with an additional correction element; and

FIG. 48 shows a field facet mirror for use in an illumination optical unit of the projection exposure apparatus according to FIG. 47, together with the correction element on an enlarged scale in a view similar to FIG. 2.

### DETAILED DESCRIPTION

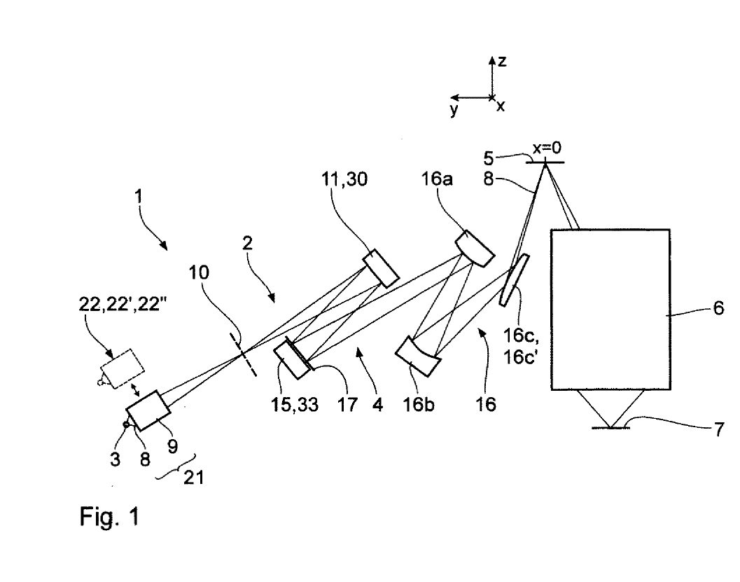

FIG. 1 schematically shows a projection exposure apparatus 1 for microlithography in a meridional section. An illumination system 2 of the projection exposure apparatus 1 has, in addition to a radiation source 3, an illumination optical unit 4 for exposing an object field in an object plane 5. A reticle that is arranged in the object field and is not illustrated in the drawing is exposed in this case. A projection optical unit 6 serves for imaging the object field into an image field in an image plane 7. A structure on the reticle is imaged onto a light-sensitive layer of a wafer that is arranged in the region of the image field in the image plane 7 and is likewise not illustrated in the drawing.

To facilitate the illustration, a system of Cartesian xyz coordinates is depicted in FIG. 1. The x direction runs perpendicular to the plane of the drawing into the latter in FIG. 1. The y direction, namely the scanning direction of reticle and wafer, runs toward the left in FIG. 1. The z direction runs toward the top in FIG. 1. The EUV radiation 8 illustrated impinges on the object plane 5 at x=0.

The radiation source 3 is an EUV radiation source with an emitted useful radiation in the range of between 10 nm and 30 nm. EUV radiation 8 that emerges from the radiation source 3 is concentrated by a collector 9. A corresponding collector is known from EP 1 225 481 A. Downstream of the collector 9, the EUV radiation 8 propagates through an intermediate focal plane 10 before it impinges on a field facet mirror 11. The EUV radiation 8 is also referred to below as illumination and imaging light.

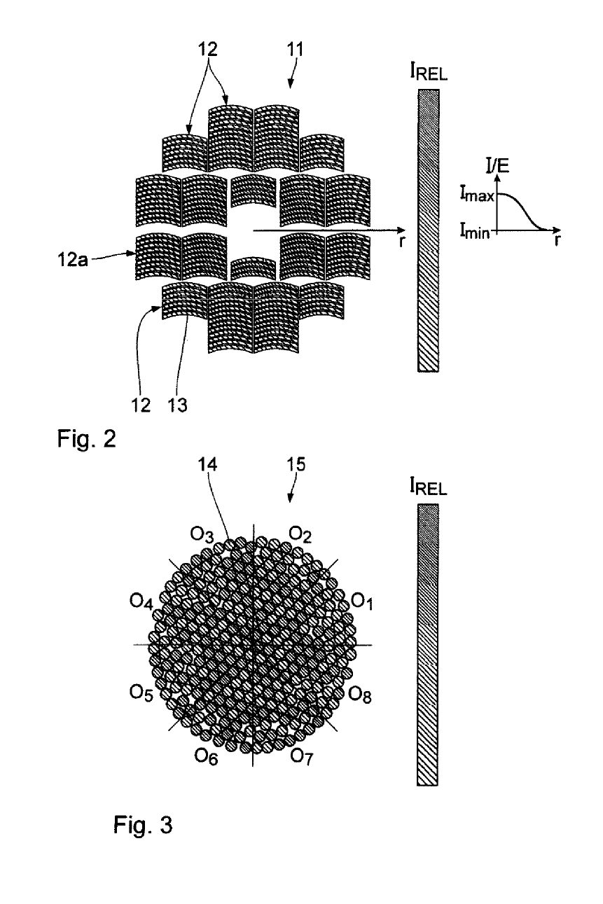

FIG. 2 shows an enlarged plan view of the field facet mirror 11. The latter comprises a plurality of facet groups 12 arranged in columns and rows, the facet groups in turn each comprising a plurality of curved individual facets 13. The field facet mirror 11 is constructed from a plurality of different types of facet groups 12 which differ in terms of the number of individual facets 13. The field facet group 12a illustrated at the bottom left in FIG. 2 is subdivided into nine individual facets 13, for example. Other field facet groups 12 have more or fewer individual facets 13. On account of a center shading produced by the collector 9, a central region of the field facet mirror 11 has no field facets.

The EUV radiation 8 reflected from the field facet mirror 11 is constructed from a multiplicity of partial beams of radiation, each partial beam being reflected by a specific individual facet 13. Each partial beam impinges in turn on an individual facet 14 (cf. FIG. 3) of a pupil facet mirror 15 that is assigned to the partial beam. The pupil individual facets 14 are round and densely packed in their arrangement, such that they are present as hexagonally densest packing particularly in the center of the pupil facet mirror 15. With the field facet mirror 11, secondary light sources are produced at the location of the individual facets 14 of the pupil facet mirror 15. The pupil facet mirror 15 is arranged in a plane of the illumination optical unit 4 which coincides with a pupil plane of the projection optical unit 6 or is optically conjugate with respect thereto. The intensity distribution of the EUV radiation 8 on the pupil facet mirror 15 is therefore directly correlated with an illumination angle distribution of the illumination of the object field in the object plane 5.

With the aid of the pupil facet mirror 15 and an imaging optical assembly in the form of a transfer optical unit 16, the field individual facets 13 of the field facet mirror 11 are imaged into the object plane 5. The transfer optical unit 16 has three reflective mirrors 16a, 16b and 16c disposed downstream of the pupil facet mirror 15.

The field individual facets 13 in the case of the field facet mirror 11 have the form of the object field to be illuminated. Such field facets are known, for example, from U.S. Pat. No. 6,452,661 and U.S. Pat. No. 6,195,201.

A correction diaphragm 17 is arranged adjacent to the reflective surface of the pupil facet mirror 15. EUV radiation 8 that passes through the illumination optical unit 4 has to pass through the correction diaphragm 17. In the beam path of the EUV radiation 8 according to FIG. 1, the EUV radiation 8 passes through the correction diaphragm 17 twice. EUV radiation is blocked by the correction diaphragm 17 in such a way that only EUV radiation passing through the passage opening 18 is transmitted by the correction diaphragm 17 and the rest of the EUV radiation 8 is blocked.

FIG. 5 shows a correction diaphragm 17. The latter has a central passage opening 18 delimited by precisely one diaphragm edge 19. Between the two o'clock position and the three o'clock position, the diaphragm edge 19 has a correction section 20 projecting in the form of a partial circle into the passage opening 18.

Apart from the correction section 20, the passage opening 18 of the correction diaphragm 17 is circular. It is only in the region of the correction section 20 that the circumferential contour, that is to say the radius in the present case, of the passage opening 18 deviates from the further radius of the passage opening 18 and is smaller there.

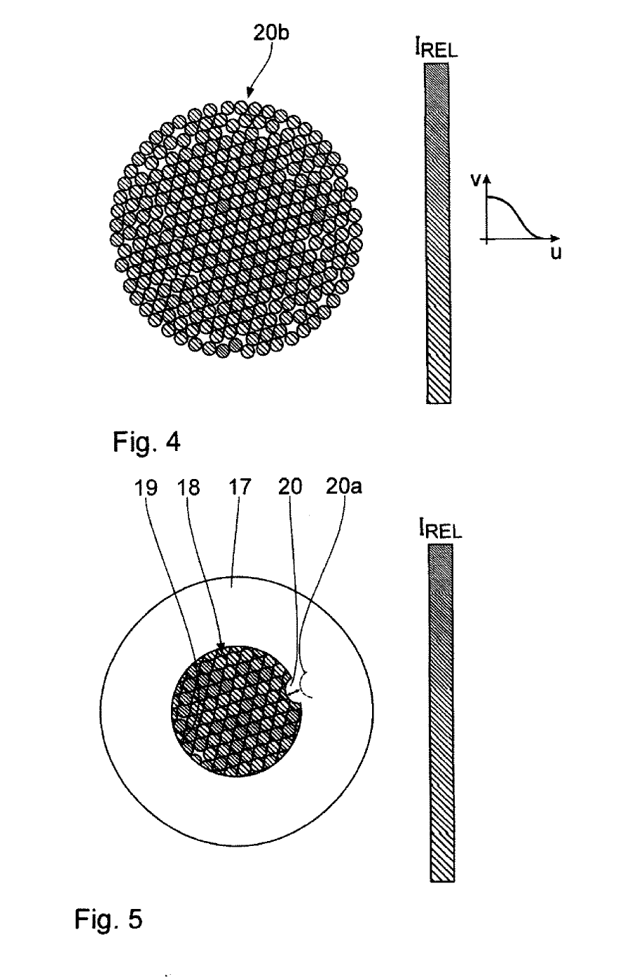

FIG. 5 additionally shows the effect of the correction diaphragm 17 on the illumination of a central object field point in the object plane 5. The illustration shows, in the interior of the passage opening 18, a scan-integrated illumination of an entrance pupil of a central object field point (x=0) in the object plane 5. The entire scan-integrated illumination of this object field point without a correction diaphragm 17 is shown in FIG. 4. The illustration therein shows, therefore, from what illumination directions, represented by the pupil individual facets 14, radiation partial beams of the EUV radiation 8 impinge with what energies or intensities on a point of the reticle in the object plane 5 which is scanned in the y direction at x=0 through the object plane.

The projection exposure apparatus 1 is of the scanner type. This means that both the reticle in the object plane 5 and the wafer in the image plane 7 are moved continuously in the y direction during the operation of the projection exposure apparatus 1.

FIG. 2 additionally illustrates the intensities or energies (I/E) with which the EUV radiation 8 impinges on the facet groups 12 of the individual facets 13. Owing to the spatial distribution of the radiation source 3 and the imaging effect of the collector 9, the intensity or energy impingement of the EUV radiation 8 on the field facet mirror 11 is not perfectly homogeneous, but rather differs over the radius r of the field facet mirror 11, as illustrated in the I/r diagram on the right in FIG. 2, between a maximum value Iₘₐₓ and a minimum value Iₘᵢₙ. Between the plan view of the field facet mirror 11 and the I/r diagram, a vertical Iᵣₑₗ subdivided into different hatching regions is illustrated in FIG. 2. The relative intensity Iᵣₑₗ is all the higher on the field individual facets 13 in accordance with these hatchings, the denser the hatching. This correspondingly holds true for the subsequent figures in which a corresponding Iᵣₑₗ bar is illustrated.

In this case, the maximum value is attained in the region of small radii, that is to say in the inner region of the field facet mirror 11 and the minimum value is attained in the region of large radii, that is to say in the outer region of the field facet mirror 11. Depending on the specifications of the radiation source 3 and of the collector 9, the ratio Iₘₐₓ/Iₘᵢₙ can be different. Ratios Iₘₐₓ/Iₘᵢₙ of between 1.05 and 10 are possible in practice. The diagram illustrated on the right in FIG. 2 schematically shows the profile of the intensity or energy I/E over the radius r. This intensity or energy decreases continuously as the radius becomes larger.

On account of the different energies or intensities which impinge on the individual facets 13 of the field facet mirror 11, different radiation partial beams of the EUV radiation that transport energies or intensities impinge on the pupil individual facets 14 as well. This is identified by different identifications of the pupil individual facets 14 in FIG. 3. Since the field individual facets 13 are oriented in such a way that adjacent field individual facets 13 illuminate pupil individual facets 14 lying further apart from one another, radiation partial beams of the EUV radiation 8 with differing energy or intensity generally impinge on adjacent pupil individual facets 14.

The impingement of the partial beams of radiation on the pupil individual facets 14 is ideally such that the energy or intensity centroid of a superposition of all the partial beams of radiation lies precisely in the center of the entrance pupil of the projection optical unit 6 and that the same energy or intensity impinges on arbitrary surface sections, such as arbitrary quadrants or generally arbitrary sectors of the entrance pupil of the projection optical unit 6.

The telecentricity is used as a measurement variable for the centroid position of the energy or intensity.

In each field point of the illuminated object field, a centroid ray of a light bundle assigned to this field point is defined. In this case, the centroid ray has the energy-weighted direction of the light bundle emerging from this field point. Ideally, for each field point, the centroid ray runs parallel to the principal ray predefined by the illumination optical unit 4 or the projection optical unit 6.

The direction of the principal ray \vec{s}₀(x,y) is known on the basis of the design data of the illumination optical unit 4 or the projection optical unit 6. The principal ray is defined at a field point by the connecting line between the field point and the midpoint of the entrance pupil of the projection optical unit 6. The direction of the centroid ray at a field point x, y in the object field in the object plane 5 is calculated as:

$$\vec{s} ( x , y ) = \frac{1}{\tilde{E} ( x , y )} \int d u d v ( \frac{u}{v} ) E ( u , v , x , y ) .$$

E(u,v,x,y) is the energy distribution for the field point x,y depending on the pupil coordinates u,v, that is to say depending on the illumination angle which the corresponding field point x, y sees. \tilde{E}(x,y)=∫dudvE(u,v,x,y) here is the total energy that impinges on the point x,y.

In the example illustrated in FIG. 3, e.g. a central object field point x₀, y₀ sees the radiation of partial beams of radiation from directions u,v which is defined by the position of the respective pupil individual facets 14. In the case of this illumination, the centroid ray s runs along the principal ray only when the different energies or intensities of the partial beams of radiation assigned to the pupil individual facets 14 combine to form a centroid ray direction which is integrated over all the pupil individual facets 14 and which runs parallel to the principal ray direction. This is manifested only in the ideal case. In practice, a deviation exists between the centroid ray direction \vec{s}(x,y) and the principal ray direction \vec{s}₀(x,y), which deviation is referred to as the telecentricity error \vec{t}(x,y):

\vec{t}(x,y)=\vec{s}(x,y)−\vec{s}₀(x,y)

During practical operation of the projection exposure apparatus 1, it is not necessary to correct the static telecentricity error in the case of a specific object field, but it is generally desirable to correct the telecentricity error that is scan-integrated at x=x₀. The latter telecentricity error results as:

$$\vec{T} ( {x}_{0} ) = \frac{\int d y \tilde{E} ( {x}_{0} , y ) \vec{t} ( {x}_{0} , y )}{\int d y \tilde{E} ( {x}_{0} , y )}$$

What is corrected, therefore, is the telecentricity error which a point (x, e.g. x₀) on the reticle that runs through the object field in the object plane 5 during scanning experiences in an integrated manner in energy-weighted fashion. In this case, a distinction is made between an x-telecentricity error and a y-telecentricity error. The x-telecentricity error is defined as the deviation of the centroid ray from the principal ray perpendicular to the scanning direction. The y-telecentricity error is defined as the deviation of the centroid ray from the principal ray in the scanning direction.

FIG. 4 shows the energy distribution 20b impinging on the point x=0, that is to say in the center of the object field, during the scan, depending on the angles u,v. That is to say that the illustration shows E′(u,v,x)=∫dyE(u,v,x,y) for x=0, that is to say for the center of the object field.

FIG. 5 shows the effect of the correction diaphragm 17 on this scan-integrated illumination according to FIG. 4. The correction section 20 screens, in sections, pupil individual facets 14 which contribute to the scan-integrated illumination with high energies or intensities. The correction section 20 therefore provides an effective correction of the centroid ray direction and thus of the telecentricity error.

In addition to the telecentricity error, the ellipticity is a further measurement variable for assessing the quality of the illumination of the object field in the object plane 5. In this case, the determination of the ellipticity permits a more precise statement about the distribution of the energy or intensity over the entrance pupil of the projection optical unit 6. For this purpose the entrance pupil is subdivided into eight octants which are consecutively numbered from O₁ to O₈ in the counterclockwise direction, as is customary mathematically, in FIG. 3. The energy or intensity contribution which the octants O₁ to O₈ of the entrance pupil contribute to the illumination of a field point is referred to hereinafter as energy or intensity contribution I₁ to I₈.

The following variable is designated as the −45°/45° ellipticity

$${E}_{- 45 ° / 45 °} = \frac{I 1 + I 2 + I 5 + I 6}{I 3 + I 4 + I 7 + I 8}$$

and the following variable is designated as the 0°/90° ellipticity

$${E}_{0 ° / 90 °} = \frac{I 1 + I 8 + I 4 + I 5}{I 2 + I 3 + I 6 + I 7} .$$

In a manner corresponding to the explanations given above with regard to the telecentricity error, it is also possible to determine the ellipticity, as in the example according to FIG. 3, for a specific object field point x₀, y₀ or alternatively for a scan-integrated illumination (x=x₀, y integrated).

The effect of the correction section 20 of the correction diaphragm 17 is such that object field points which are illuminated by the EUV radiation 8 passing through the correction diaphragm 17 are illuminated in a scan-integrated manner with a centroid ray direction parallel to the principal ray (telecentricity error=0) and the same energy or intensity impinges on them from all eight octants O₁ to O₈ of the entrance pupil (E_{-45°/45°}=E_{0°/90°}=1).

In the case of the projection exposure apparatus 1, an illumination module 21 comprising the radiation source 3 and the collector 9 can be exchanged for a replacement illumination module 22 comprising a different radiation source and a different collector adapted thereto. In some embodiments, it is also possible to replace only the radiation source 3 or only the collector 9, the respective other component 9, 3 remaining in the projection exposure apparatus 1.

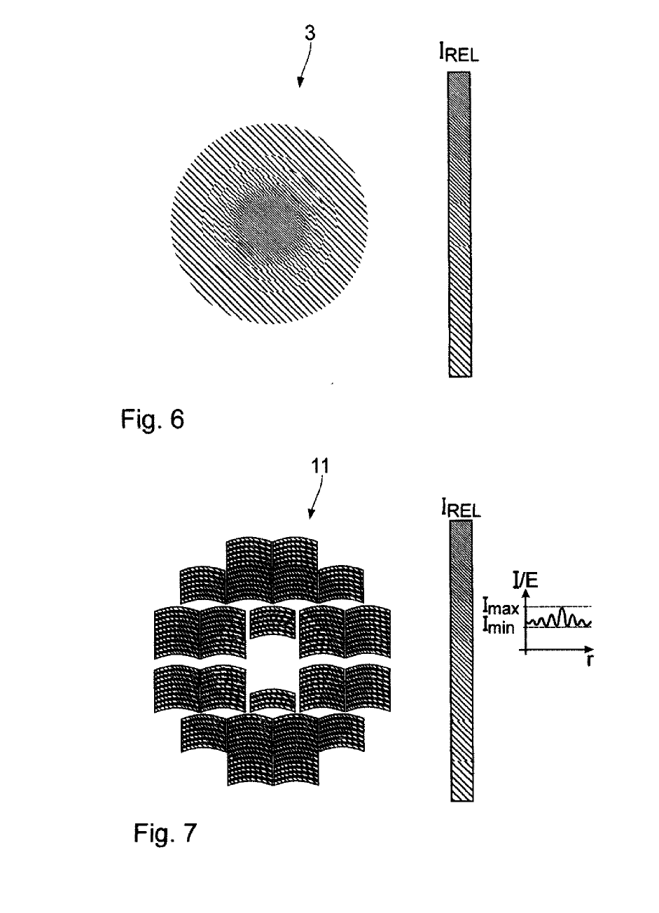

FIG. 6 shows an energy distribution, produced by the replacement illumination module 22, in the intermediate focal plane 10. The associated radiation source 3 has the form of an ellipsoid having one long principal axis and two short principal axes of identical length. In this case, the long axis lies in the ray direction between the collector 9 and the field facet mirror 11.

FIG. 7 shows the distribution of the intensity or energy I/E over the radius of the field facet mirror 11, produced by illumination with the replacement illumination module 22. The energy or intensity oscillates over the radius r of the field facet mirror 11 between a minimum energy or intensity Iₘᵢₙ and a maximum energy or intensity Iₘₐₓ. The explanations given above in connection with the distribution according to FIG. 2 hold true for the ratio Iₘₐₓ/Iₘᵢₙ.

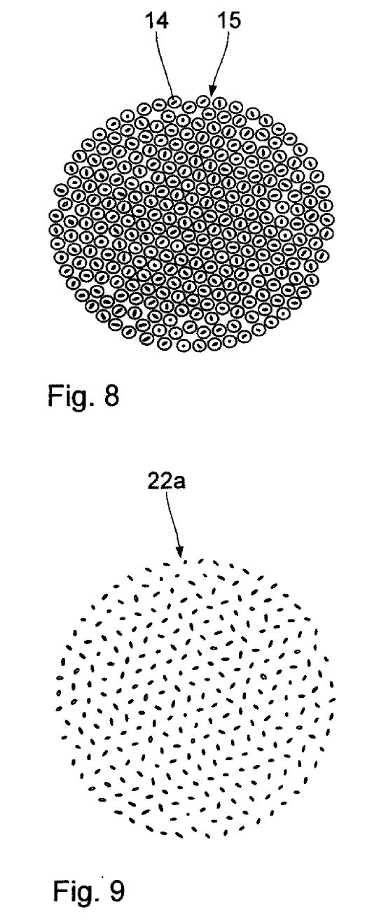

The illumination of the field facet mirror 11 in accordance with FIG. 7 leads to an illumination of the pupil facet mirror 15 which is indicated schematically in FIG. 8. Within the round pupil facets 14, only a central section of these individual facets 14 is illuminated in each case. This central illumination of the individual facets 14 is also referred to as a source image. There arises in a scan-integrated manner in the entrance pupil of the projection optical unit 6 an illumination 22a for an object field point at x=0, which is illustrated in FIG. 9.

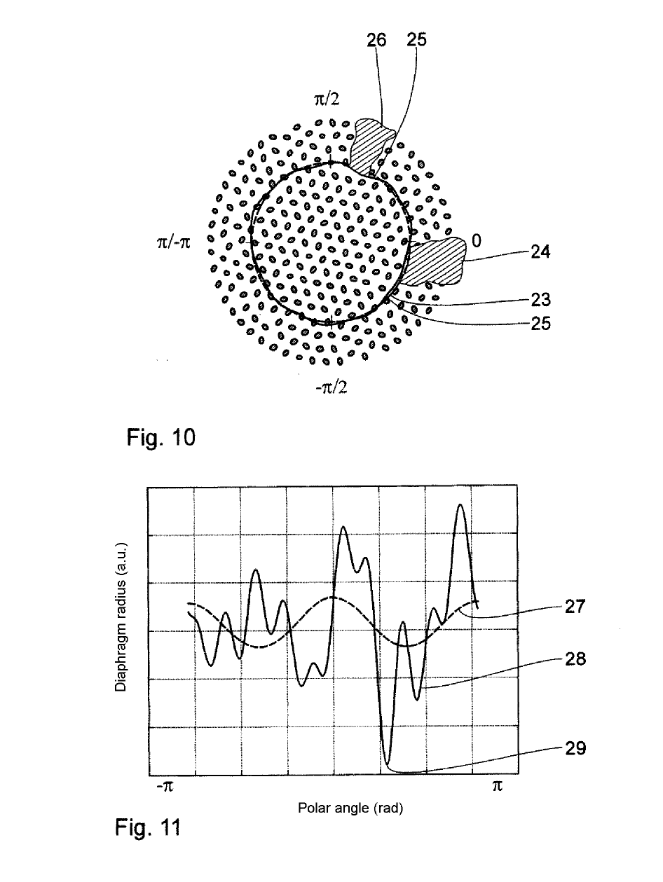

FIG. 10 shows, using a dashed line, an entire inner diaphragm edge 23 of an uncorrected diaphragm 24, which is illustrated only in regions in a circumferential section, and, using a solid line, an entire inner diaphragm edge 25 of a correction diaphragm 26, which is likewise illustrated only in regions in a circumferential section.

FIG. 11 illustrates the exact radius profile of the diaphragm edges 23 and 25 in polar coordinates in magnified fashion. In this case, a cosinusoidal dashed radius profile 27 is associated with the uncorrected diaphragm 24. A solid radius profile 28 modulated to a greater extent and at a higher frequency in comparison with the radius profile 27 is associated with the correction diaphragm 26. The radius profiles according to FIG. 11 begin at −π at a circumferential point which lies in the 9 o'clock position in FIG. 10, the inner diaphragm edge 23, 25 subsequently being traversed in the counterclockwise direction. A characteristic global minimum 29 of the radius profile 28 of the correction diaphragm 26 shortly before π/2 is found in the illustration according to FIG. 10 approximately in the 1 o'clock position, where the correction diaphragm 26 is illustrated in regions.

The circumferential contour of an uncorrected diaphragm 24 constitutes the start point of an optimization algorithm for calculating the form of the correction diaphragm 26 for which both the telecentricity error and the ellipticity error assume as favorable low values as possible. The profile of the correction diaphragm 26 deviates along the diaphragm edge from the uncorrected circumferential contour of the diaphragm 24 continuously by a correction magnitude.

A conventional illumination setting with σ=0.5 can be realized with the diaphragms 24, 26. This means that only half of the maximum possible aperture radius of the projection optical unit 6 is illuminated.

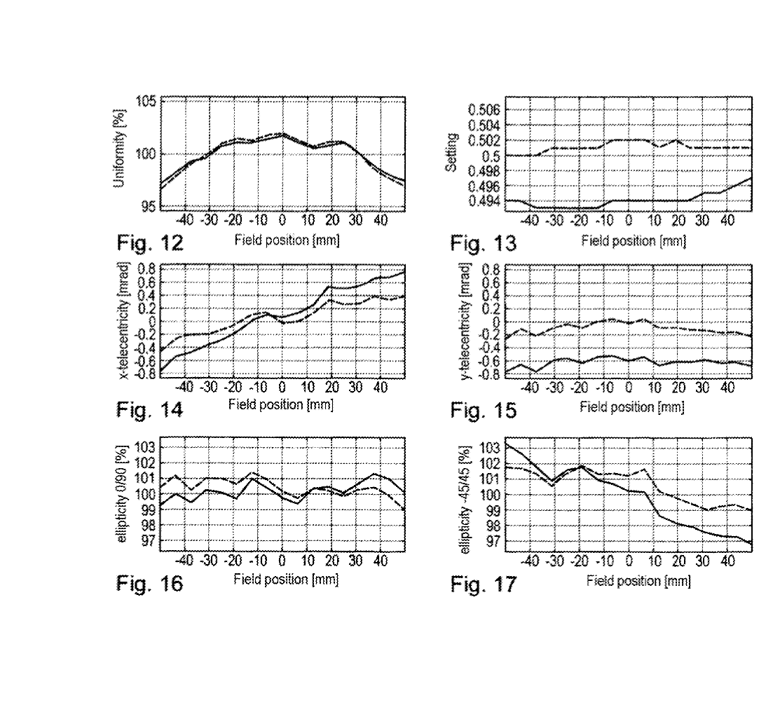

A performance comparison of the projection exposure apparatus 1 with the uncorrected diaphragm 24, on the one hand, and the correction diaphragm 26 is illustrated in FIGS. 12 to 17 on the basis of parameter diagrams. In each case the parameter profile when using the uncorrected diaphragm 24 is illustrated by a solid line and the parameter profile when using the correction diaphragm 26 is illustrated by a dashed line. The parameters are illustrated in each case in scan-integrated fashion between x=−50 mm and x=50 mm.

FIG. 12 shows the profile of the uniformity versus the field position between x=−50 mm and x=+50 mm in scan-integrated fashion. In this case, the uniformity represents the integral of the energy or intensity which each object field point sees in scan-integrated fashion, independently of the direction from which the radiation is incident.

FIG. 13 shows the σ value. It can clearly be seen that with the use of the correction diaphragm 26, the setting can be kept constant between 0.5 and 0.502 with small deviations over the entire field region.

FIG. 14 shows the x-telecentricity in mrad. The x-telecentricity is defined as the deviation of the centroid ray from the principal ray in the x direction, that is to say perpendicular to the scanning direction. It can be discerned clearly that the variation range of the x-telecentricity when using the correction diaphragm 26 is distinctly reduced in comparison with the variation range of the x-telecentricity when using the uncorrected diaphragm 24. The x-telecentricity varies only between −0.4 and +0.4 mrad over the entire object field when using the correction diaphragm 26.

FIG. 15 shows the y-telecentricity, likewise in mrad. The y-telecentricity is defined as the deviation of the centroid ray from the principal ray in the scanning direction y. The y-telecentricity can be kept between −0.2 and 0 mrad practically over the entire field when using the correction diaphragm 26.

FIG. 16 shows the ellipticity E_{0°/90°} in percent. At this value, which is good even when the uncorrected diaphragm 24 is used, no significant difference is produced by using the correction diaphragm 26.

FIG. 17 shows the profile of the ellipticity E_{-45°/45°} versus the field. It can clearly be seen how the use of the correction diaphragm 26 brings about a significant reduction of the bandwidth of the ellipticity values in comparison with the uncorrected diaphragm 24. The ellipticity varies only between 99 and 102% when using the correction diaphragm 26.

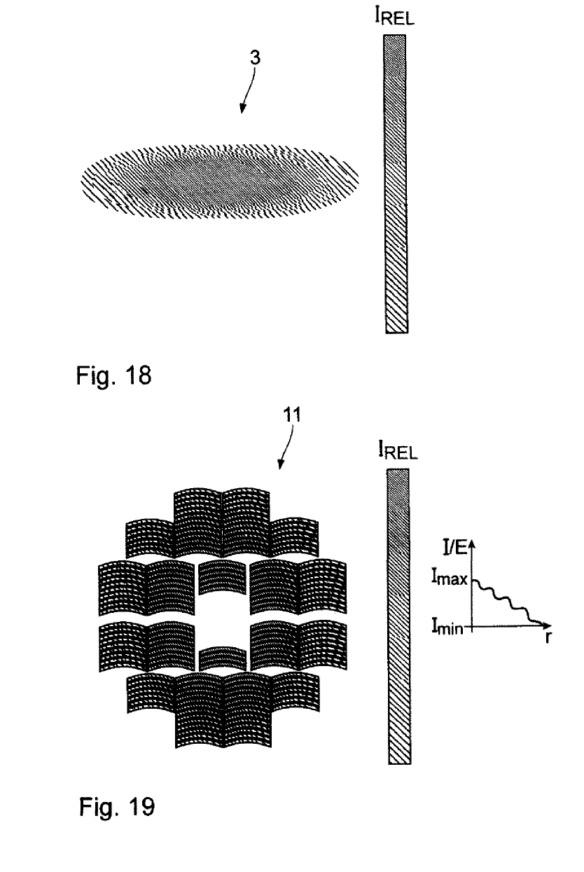

A replacement illumination module 22′ and of a further correction diaphragm is described below with reference to FIGS. 18 to 29. Components corresponding to those which have already been explained above with reference to FIGS. 1 to 17 bear the same reference numerals and will not be discussed in detail again.

In the case of FIGS. 18 to 29, only the radiation source 3 is replaced, but not the collector 9.

FIG. 18 shows the profile of the energy or intensity when using the replacement illumination module 22′ in the intermediate focal plane 10. In the case of the replacement illumination module 22′, the radiation source 3 is an emitter in the form of an ellipsoid, the long principal axis of which lies perpendicular to the ray direction between the collector 9 and the field facet mirror 11.

Use of the replacement illumination module 22′ results in an illumination of the field facet mirror 11 with an energy or intensity I/E which is illustrated qualitatively in the right-hand diagram in FIG. 19. The energy or intensity decreases in undulatory or stepped fashion between a higher energy or intensity Iₘₐₓ and a lower energy or intensity Iₘᵢₙ. The explanations given above in connection with the intensities Iₘᵢₙ, Iₘₐₓ according to FIG. 2 hold true for the ratio of the two intensities.

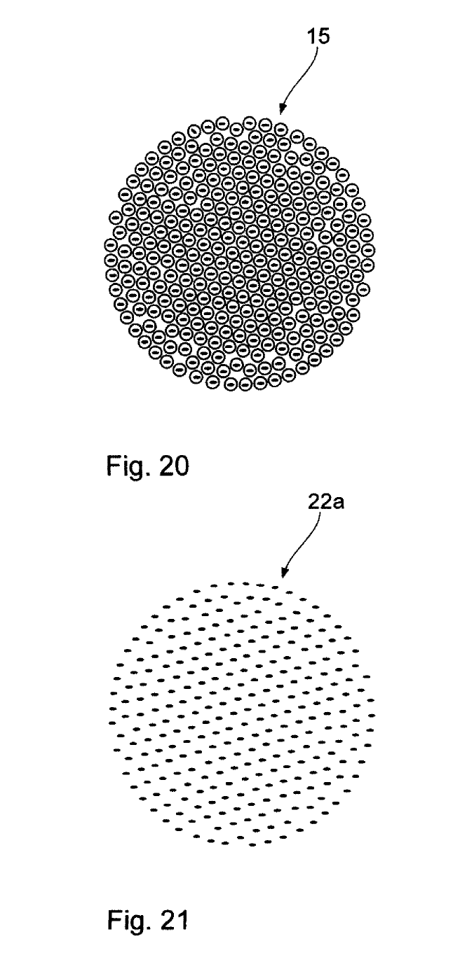

FIG. 20 schematically shows, in a manner corresponding to FIG. 8, the illumination of the pupil facet mirror 15 when the replacement illumination module 22′ is used.

FIG. 21 shows, in a manner corresponding to FIG. 9, the scan-integrated illumination of an object field point in the field center (x=0) through the pupil facet mirror 15.

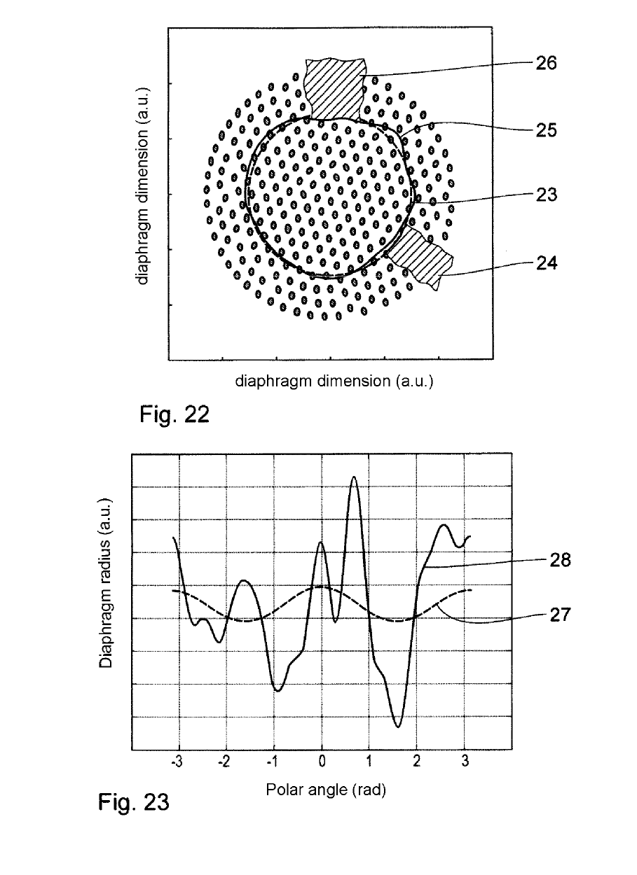

FIG. 22 shows, in a manner corresponding to the illustration according to FIG. 10, the uncorrected diaphragm 24 and the correction diaphragm 26 configured in a manner coordinated with the replacement illumination module 22′. FIG. 23 shows, in a manner corresponding to FIG. 11, the polar coordinate profile of the radii of the inner diaphragm edges 23 (uncorrected diaphragm 24) and 25 (correction diaphragm 26).

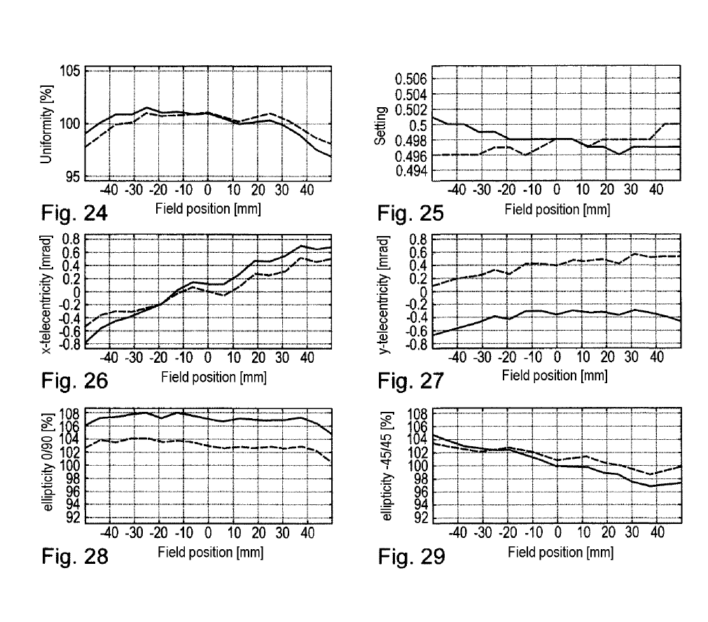

FIGS. 24 to 29 show the corrective effect of the correction diaphragm 26 in comparison with the uncorrected diaphragm 24 in an illustration corresponding to that according to FIGS. 12 to 17. The x-telecentricity varies only between −0.5 and 0.5 mrad when the correction diaphragm 26 is used. The y-telecentricity varies only between 0.1 and 0.55 mrad. The ellipticity E_{0°/90°} varies only between 100 and 104%. The ellipticity E_{45°/45°} varies only between 99 and 103%.

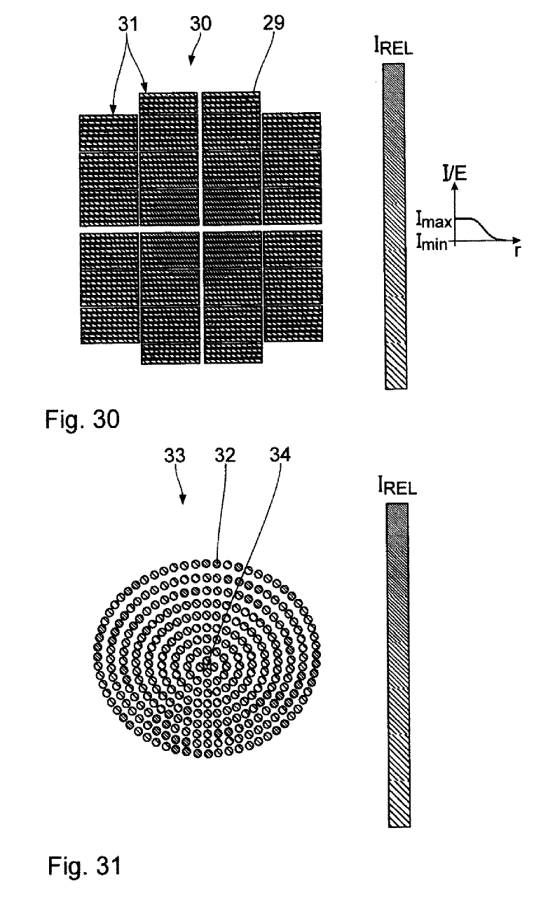

A projection exposure apparatus with the use of a replacement illumination module 22″ and a further correction diaphragm is illustrated below with reference to FIGS. 30 to 40. Components corresponding to those which have already been described above with reference to FIGS. 1 to 29 bear the same reference numerals and will not be explained in detail again.

In the case of the replacement illumination module 22″, use is made of a radiation source configured as a surface emitter with angle-dependent emission.

Individual facets 29 of a field facet mirror 30, which is used instead of the field facet mirror 11 in FIGS. 30 to 40, are not curved but rather elongated-rectangular. The individual facets 29 are combined to form rectangular facet groups 31.

In the case of FIGS. 30 to 40, the individual facets 29 and the facet groups 31 of the field facet mirror 30 do not have the form of the object field to be illuminated in the object plane 5. A mirror 16c′ that shapes the illumination field in the object plane 5 is used instead of the mirror 16c near the object field. In order to compensate for a distortion produced by this field-shaping mirror 16c′, pupil individual facets 32 of a pupil facet mirror 33, which is used instead of the pupil facet mirror 15, are not arranged rotationally symmetrically about an origin 34, as in the case of the pupil facet mirror 15, but rather in a manner deformed in compensating fashion. In the case of the pupil facet mirror 33, this is effected by an arrangement of the pupil individual facets 32 in not completely concentric facet rings, the distance between the facet rings being larger above the origin 34 than below the origin in FIG. 31.

In addition to the distribution of the pupil individual facets 32, FIG. 31 also shows the illumination of the pupil individual facets 32 with radiation partial beams of the EUV radiation 8 having differing energy or intensity on account of the illumination of the assigned field individual facets 29 of the field facet mirror having differing energy or intensity, as indicated in the diagram on the right-hand side in FIG. 30. In a manner similar to that in the case of the illumination of the field facet mirror 11 according to FIG. 2, in the case of the illumination of the field facet mirror 30 according to FIG. 30 as well, a central region is illuminated with higher energy or intensity than an edge region. The intensity or energy (I or E) decreases from a central intensity Iₘₐₓ continuously toward an edge-side intensity or energy Iₘᵢₙ. The explanations given above in connection with the corresponding ratio in the case of the illumination according to FIG. 2 are true for the ratio Iₘₐₓ/Iₘᵢₙ.

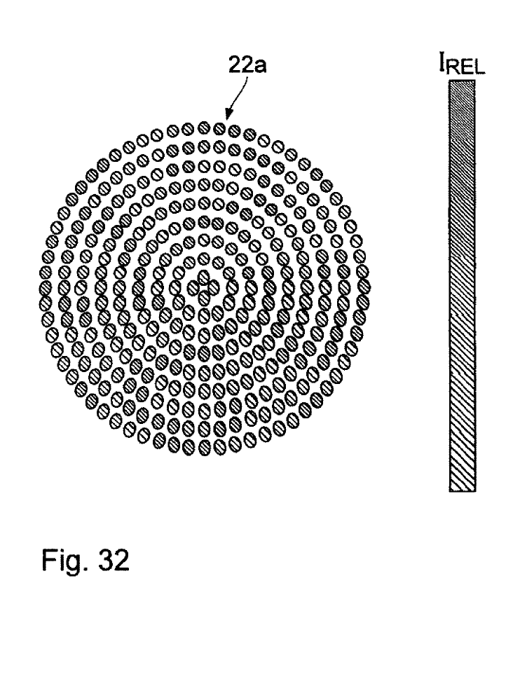

FIG. 32 in turn shows schematically a scan-integrated illumination of a central object field point (x=0).

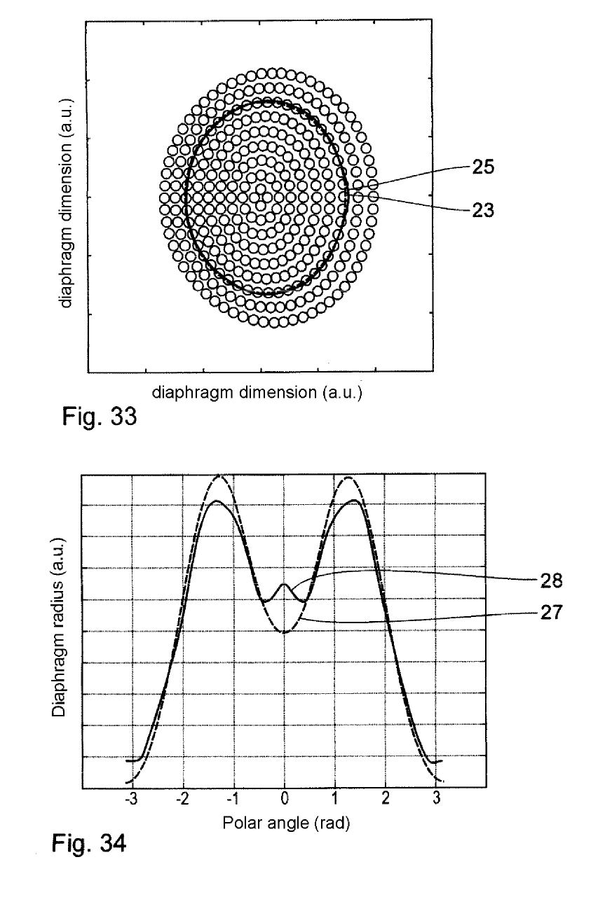

FIG. 33 shows, in a manner corresponding to FIG. 10, inner diaphragm edges 23, 25 of an uncorrected diaphragm 24, on the one hand, and of a correction diaphragm 26, on the other hand. FIG. 34 shows, in a manner corresponding to FIG. 11 in a polar coordinate illustration, the radius profiles 27, 28 of the uncorrected diaphragm 24, on the one hand, and of the correction diaphragm 26, on the other hand. What is characteristic of the correction diaphragm 26 is a further local maximum at the polar coordinate 0, that is to say in the 3 o'clock position in FIG. 33. As a result of this, pupil individual facets 29 located there of the—as seen from the outside—third facet ring are still transmitted completely when the correction diaphragm 26 is used, while they are cut off almost by half when the uncorrected diaphragm 24 is used.

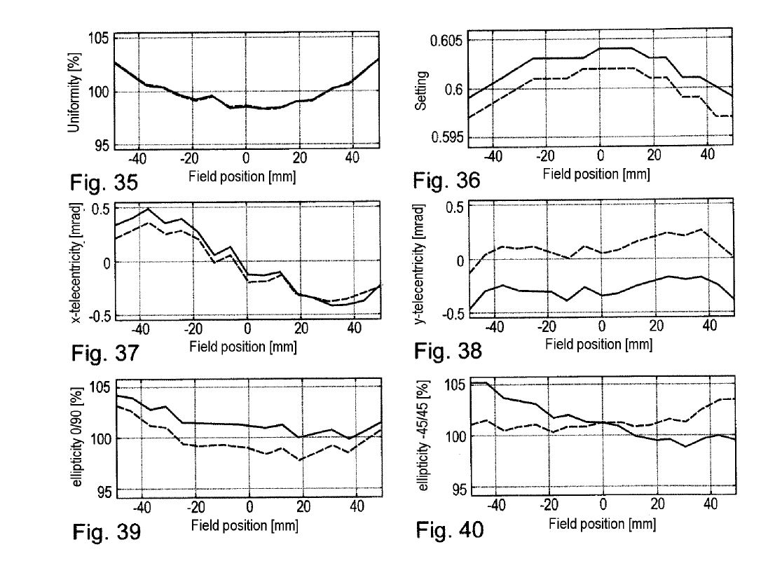

FIGS. 35 to 40 show, in a manner corresponding to FIGS. 12 to 17, the field profile of the optical variables of uniformity, setting, telecentricity and ellipticity.

The set target setting σ=0.6 is always attained with only small deviations, as seen over the entire field, when the correction diaphragm 26 is used. Primarily the y-telecentricity is greatly improved with the use of the correction diaphragm 26 in comparison with the use of the uncorrected diaphragm 24 and has only small deviations from 0. The fluctuation ranges in the case of the ellipticities E_{0°/90°} and E_{-45°/45°} are also reduced with the use of the correction diaphragm 26 in comparison with the use of the uncorrected diaphragm 24.

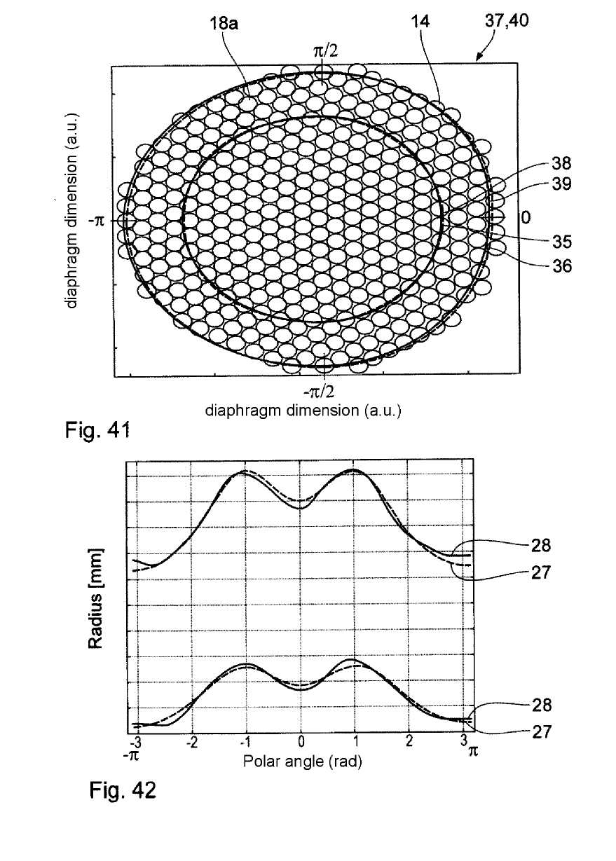

FIGS. 41 to 46 show a correction diaphragm and the effect thereof. Components corresponding to those which have already been illustrated above with reference to FIGS. 1 to 40 bear the same reference numerals and will not be explained in detail again.

In the case of FIG. 41, one of the illumination modules already described above is used, e.g. the illumination module 21.

FIG. 41 shows, using dashed lines, an inner diaphragm edge 35 and an outer diaphragm edge 36 of an uncorrected annular diaphragm 37, which can be arranged instead of the correction diaphragm 17 or 26 in order to produce an annular illumination setting. The corrected diaphragm 37 transmits EUV radiation 8 exclusively in the ring between the inner diaphragm edge 35 and the outer diaphragm edge 36.

FIG. 41 illustrates, using solid lines, an inner diaphragm edge 38 and an outer diaphragm edge 39 of a correction diaphragm 40, which can be used instead of the correction diaphragms 17, 26 in the projection exposure apparatus 1 according to FIG. 1. The diaphragm edges 38, 39 delimit a ring-shaped passage opening 18a.

The radius profiles 27, 28 of the diaphragm edges 35, 38, on the one hand, and 36, 39, on the other hand, differ to such a small extent that the lines identifying them in FIG. 41 run one above another in regions. The differences between the radius profiles 27 of the uncorrected diaphragm 37 and 28 of the correction diaphragm 40 become clearer in the polar illustration according to FIG. 42, which illustrates the radius profiles 27, 28 between −π and π. It can clearly be seen that in the case of a polar angle 0, that is to say in the 3 o'clock position in FIG. 41, the uncorrected diaphragm 37 both at the inner diaphragm edge 35 and at the outer diaphragm edge 36 has a larger radius than the correction diaphragm 40 at the inner diaphragm edge 38 and at the outer diaphragm edge 39. This has the effect that the correction diaphragm, in the region of the 3 o'clock position, transmits less light of the outer pupil individual facets 14 and more light of the inner pupil individual facets 14.

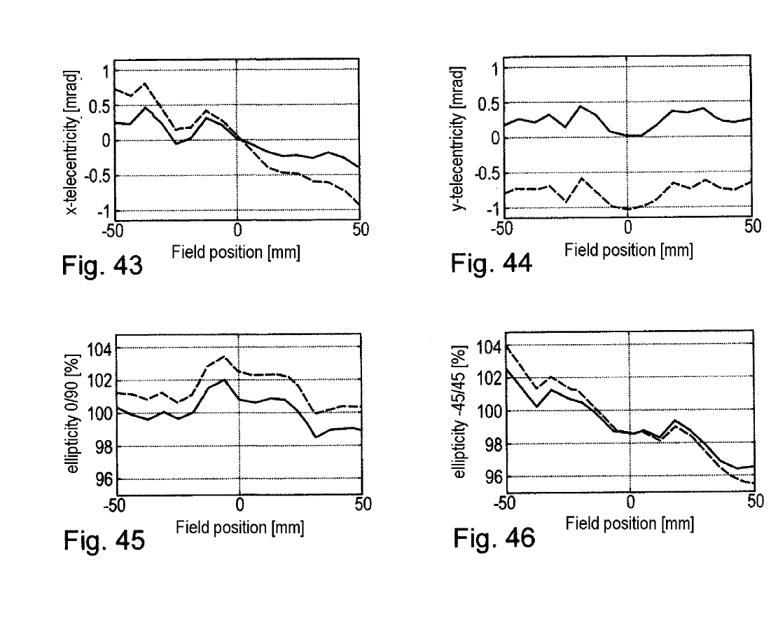

FIGS. 43 to 46 show, in a parameter illustration corresponding to that in FIGS. 14 to 17, the effect of the correction diaphragm 40 on the optical parameters of telecentricity and ellipticity.

FIG. 43 shows that the x-telecentricity varies only in a small interval between 0.5 and −0.5 mrad when the correction diaphragm 40 is used.

FIG. 44 shows that the y-telecentricity varies only between 0 and 0.5 mrad when the correction diaphragm 40 is used.

FIG. 45 shows that the ellipticity E_{0°/90°} varies only between 98.5% and 103% when the correction diaphragm 40 is used.

FIG. 46 shows that the variation of the ellipticity E_{-45°/45°} also varies to a lesser extent, namely between 96.5% and 102.5%, with the use of the correction diaphragm 40 than with the use of the uncorrected diaphragm 37.

As an alternative to the optical design of the projection exposure apparatus 1 according to FIG. 1, the projection optical unit 6 can be configured in such a way that the entrance pupil thereof lies in the region of the optical components of the illumination optical unit 4. It is thereby possible to dispense with the imaging mirrors 16a, 16b of the transfer optical unit 16 for forming a conjugate pupil plane in the region of the pupil facet mirror 15. In this case, the pupil facet mirror 15 is arranged directly in the entrance pupil plane of the projection optical unit 6 and the light emerging from the pupil facet mirror 15 is directed via a deflection mirror, which is arranged in a similar manner to the mirror 16c, directly to the object plane 5.

The correction diaphragms 17, 26, 40 can also be arranged in a conjugate pupil plane with respect to the pupil plane in which the pupil facet mirror 15, 33 is arranged. The arrangement can then be such that the EUV radiation 8 passes through the correction diaphragm 17, 26, 40 only once, that is to say not in a forward and return pass.

The correction diaphragms 17, 26, 40 screen the pupil facet mirror in such a way that at least some pupil individual facets 14, 32 of the pupil facet mirror 15, 33 are partly shaded by one and the same diaphragm edge 19, 25, 38, 39.

The correction diaphragm 17 has a static diaphragm edge 19. As an alternative, the diaphragm edge can be adjustable in its radius at least in the correction section 20. This can be effected, for example, by a movable tongue 20a (cf. FIG. 5) which can be introduced into the passage opening 18 or withdrawn from the latter in the direction of a double-headed arrow 20b.

The diaphragm edges 28 and 38, 39 of the correction diaphragms 26, 40 can also be adjustable in their radius profiles. This can be realized by construction of the correction diaphragms 26, 40 in a segmented design, for example, in the manner of an iris diaphragm or by construction of the correction diaphragms 26, 40 with edge sections that can be moved independently of one another.

In the case of the adjustable annular correction diaphragm 40, it is possible for only one of the two diaphragm edges to be adjustable. As an alternative, it is also possible to make both diaphragm edges, that is to say the inner diaphragm edge and the outer diaphragm edge, adjustable.

Correction diaphragms in the manner of the correction diaphragms 17, 26, 40 which have been described above with reference to FIGS. 1 to 46 are not restricted to conventional or annular settings. Correction diaphragms equipped with specially shaped boundary edges in the same way can also be used for setting a dipole setting, quadrupole setting, a multipole setting or else some other, exotic setting. Examples of such settings are found in U.S. Pat. No. 6,452,661 B1. Dipole and quadrupole correction diaphragms have two and four passage openings, respectively, which are delimited by an outer diaphragm edge. In the case of the correction diaphragms, in contrast, for example, to those according to U.S. Pat. No. 6,452,661 B1, the form of at least one of the diaphragm edges is predefined for the partial shading of individual facets of the pupil facet mirror for the correction of the telecentricity and the ellipticity of the illumination.

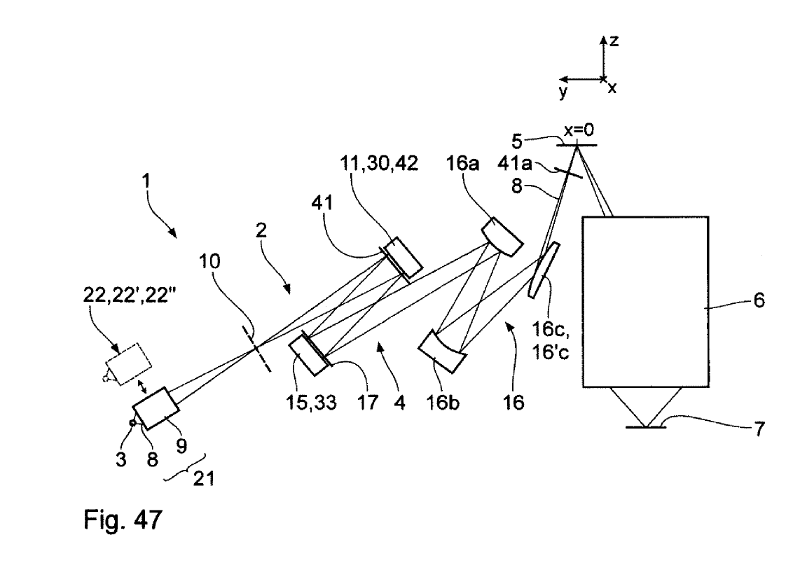

FIG. 47 shows a projection exposure apparatus 1. The latter is described below only where it differs from the one illustrated in FIG. 1. The projection exposure apparatus 1 according to FIG. 47 has a uniformity correction element 41 adjacent to the field facet mirror 11, 30. The uniformity correction element can be constructed, for example, in the manner described in EP 1 291 721 A1, that is to say can have a plurality of rotatable individual blades. As an alternative, the uniformity correction element 41 can also be constructed in the manner described in U.S. Pat. No. 6,013,401 A1. The uniformity correction element 41 is arranged adjacent to the field facet mirror 11, 30, that is to say in the region of a field plane of the projection optical unit 6. An alternative position 41a of the uniformity correction element is indicated adjacent to the object plane 5 in FIG. 47.

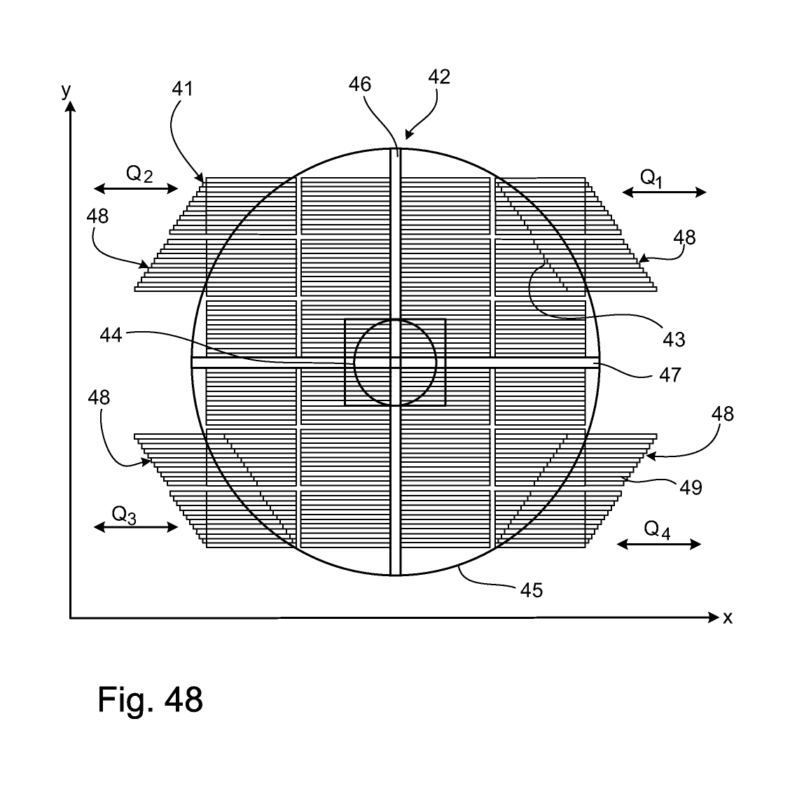

A further variant of a uniformity correction element 41 is described below with reference to FIG. 48 in connection with a field facet mirror 42, which can be used instead of the field facet mirrors 11, 30 in the projection exposure apparatus 1. The field facet mirror 42 is subdivided into a total of 312 field individual facets 43. The field individual facets 43, like the field individual facets of the field facet mirrors 11, 30, are fitted to a carrier structure (not illustrated) of the field facet mirror 42. The field individual facets 43 are rectangular, the short side of the field individual facets 43 running along the scanning direction y and the long side running perpendicular thereto, that is to say along the x direction.

FIG. 48 shows by way of example and schematically an annular illumination of the field facet mirror 42 between an inner illumination radius 44 and an outer illumination radius 45.

The field individual facets 43 are subdivided into four columns and 72 rows. The field individual facets 43 are arranged in blocks arranged one below another and each having 13 field individual facets 43. Six of these blocks arranged one below another in each case form a column of the field facet mirror 42. A first shadow 46 of spokes of the shells of the collector 9 of the illumination system 2 is illustrated between the two inner columns. Together with a second shadow 47 arranged perpendicular thereto, this results in a centered cross-shaped shadow structure on the field facet mirror 42. The arrangement of the field individual facets 43 in the case of the field facet mirror 42 can be such that no field facets are arranged in the region of the two shadows 46, 47.

The two shadows 46, 47 subdivide the field facet mirror into four quadrants Q1 to Q4. Each of these quadrants is assigned a diaphragm group 48. The four diaphragm groups 48 together form the uniformity correction element 41 of FIG. 48. Each diaphragm group 48 has two subgroups of individual finger diaphragms 49 which are in each case assigned to two outer blocks of field individual facets 43 in the quadrants Q1 to Q4. The assigned blocks are those whose field individual facets 43 are subdivided into an illuminated and an unilluminated portion by the outer illumination radius 45.

The individual finger diaphragms 49 of the four diaphragm groups 48 can be displaced independently of one another in the x direction, such that they can shade the illuminated portions of the field individual facets 43 assigned to them in regions in a defined manner. This shading in regions influences the intensity with which the pupil individual facets assigned to these field individual facets 43 are illuminated. Directly related to this illumination is the uniformity, that is to say the variation of the intensity or energy which a wafer section sees during a scan through the image field.

During the operation of the projection exposure apparatus 1, it is possible to change between different corrected settings by changing between the correction diaphragms 17, 26, 40. The illumination setting can be changed in various ways here, as is known per se from the prior art. One possibility for changing the setting is to mask out the illumination light in a targeted manner in the pupil plane. The correction diaphragms 17, 26, 40 themselves are used for this purpose. A change of illumination setting can also be effected by masking out field individual facets in a targeted manner, such that correspondingly specific pupil individual facets are no longer illuminated, which likewise changes the illumination angle distribution in the image field. The uniformity correction element 41 can also be used for masking out the field facets. By way of example, with the individual finger diaphragms 49 it is possible to bring about a corresponding targeted shading of the field individual facets 43 and hence a shading of the pupil individual facets assigned thereto with corresponding effects on the illumination setting. Finally, a variant of the change of illumination setting which is described in U.S. Pat. No. 6,658,084 B2 is possible. In this case, for changing the setting, the field individual facets are variably assigned to the pupil individual facets.

An adaptation or an exchange of the uniformity correction element 41 can be disposed downstream of the change of the illumination setting and/or of the change between different illumination modules. This takes account of the circumstance that the change of illumination setting or the change of the illumination module can affect the uniformity, which can be corrected again with the aid of the uniformity correction element 41. The steps of “change of the illumination setting” and/or “change of the illumination module”, on the one hand, and also “adaptation and/or exchange of the uniformity correction element” can be carried out iteratively in order to achieve a specific target illumination setting with a desired uniformity.

An operating method in the projection exposure apparatus 1 which involves changing between different illumination modules 21, 22, 22′, 22″ is additionally possible. For this purpose, the projection exposure apparatus 1 is firstly illuminated with a first one of the illumination modules 21, 22, 22′, 22″. In this case, the respective correction diaphragm 17, 26, 40 is used which is provided for the correction of the telecentricity and the ellipticity of the illumination with the respective illumination module 21, 22, 22′, 22″. The illumination module is subsequently replaced by a second illumination module. By way of example, the illumination module 21 can be exchanged for the replacement illumination module 22. In this case, the correction diaphragm in accordance with FIG. 10 is replaced by the correction diaphragm 26 in accordance with FIG. 22. The projection exposure apparatus 1 can subsequently continue to be operated with the replacement illumination module 22.

The correction diaphragms 17, 26, 40 can be arranged adjacent to the pupil facet mirror 15, 33 or else in the region of a conjugate pupil plane of the illumination optical unit 4 with respect to the pupil facet mirrors 15, 33. In each case at least some source images assigned to the individual facets 14, 32 of the pupil facet mirror 15, 33 in the entrance pupil of the projection optical unit 6 are partly shaded by one and the same diaphragm edge 19, 25, 38, 39 of the correction diaphragm 17, 26, 40.

The use of the correction diaphragms 17, 26, 40 also makes it possible to compensate for a distortion aberration caused by the transfer optical unit 16, such as by the mirror 16c for grazing incidence (grazing incidence mirror). Reference is made to such a distortion aberration for example in EP 1 067 437 B1 in connection with the description of FIGS. 18 to 22 therein. It is possible, for example, by the use of an elliptical correction diaphragm at the location of the correction diaphragm 17 in FIG. 1 and the predefinition—effected thereby—of a beam of the EUV radiation 8, the beam being elliptical in the pupil plane, to obtain an illumination angle distribution for the field points in the object plane 5 which is nevertheless rotationally symmetrical on account of the distortion effect of the downstream transfer optical unit 16. This distortion compensation can also be brought about by some other, non-rotationally symmetrical form of the diaphragm edge of the correction diaphragm at the location of the correction diaphragm 17. The precise form of the diaphragm edge is predefined depending on the downstream distortion effect of the transfer optical unit 16.

1. A projection exposure apparatus, comprising:
an illumination optical unit configured to illuminate an object field in an object plane during use, the illumination optical unit comprising an imaging optical assembly in a beam path upstream of the object plane, the imaging optical assembly configured to guide illumination and imaging light into the object field during use;
a projection optical unit configured to image the object field into an image field in an image plane during use; and
a correction diaphragm having a diaphragm edge configured to partially shade the illumination and imaging light during use so that an influence of a distortion aberration, arising as a result of reflection of the illumination and imaging light at components of the imaging optical assembly, on an illumination angle distribution of the illumination of the object field is at least partly compensated for,
wherein the projection exposure apparatus is configured to be used in microlithography.

2. The projection exposure apparatus according to claim 1, wherein the correction diaphragm is in or adjacent to a pupil plane of the projection optical unit.

3. The projection exposure apparatus according to claim 1, wherein the correction diaphragm is arranged in or adjacent to a plane which is conjugate to a pupil plane of the projection optical unit.

4. The projection exposure apparatus according to claim 1, wherein the illumination optical unit comprises a pupil facet mirror comprising a plurality of individual facets on which illumination light can impinge during use, and the pupil fact mirror is in a plane of the illumination optical unit that coincides with a pupil plane of the projection optical unit or that is optically conjugate with respect thereto.

5. The projection exposure apparatus according to claim 4, wherein the correction diaphragm is arranged so that at least some source images in an entrance pupil of the projection optical unit which are assigned to the individual facets of the pupil facet mirror are partly shaded by the diaphragm edge during use.

6. The projection exposure apparatus according to claim 1, wherein the illumination optical unit comprises a field facet mirror having field facets, and the imaging optical assembly is arranged so that the field facets are imaged into the object field during use.

7. The projection exposure apparatus according to claim 6, wherein the field facets are arcuate.

8. The projection exposure apparatus according to claim 1, wherein the imaging optical assembly comprises a mirror for grazing incidence.

9. The projection exposure apparatus according to claim 4, wherein the correction diaphragm is adjacent to the pupil facet mirror.

10. The projection exposure apparatus according to claim 1, wherein the correction diaphragm has at a circumferential position of the diaphragm edge at least one correction section at which the circumferential contour of the diaphragm edge deviates from a further, uncorrected circumferential contour by a correction magnitude.

11. A projection exposure apparatus, comprising:
an illumination optical unit configured to illuminate an object field in an object plane during use;
a projection optical unit configured to image the object field into an image field in an image plane during use;
a pupil facet mirror comprising a plurality of individual facets on which illumination light can impinge during use, the pupil facet mirror being in a plane of the illumination optical unit that coincides with a pupil plane of the projection optical unit or that is optically conjugate with respect thereto; and
a correction diaphragm adjacent to a pupil plane of the projection optical unit or is in a conjugate plane with respect thereto, the correction diaphragm being configured so that during use the correction diaphragm screens illumination of an entrance pupil of the projection optical unit so that at least some source images in the entrance pupil of the projection optical unit which are assigned to the individual facets of the pupil facet mirror are partly shaded by the diaphragm edge,
wherein the projection exposure apparatus is configured to be used in microlithography.

12. The projection exposure apparatus according to claim 11, wherein the correction diaphragm is adjacent to the pupil facet mirror.

13. The projection exposure apparatus according to claim 11, wherein the correction diaphragm has at a circumferential position of a diaphragm edge at least one correction section at which the circumferential contour of the diaphragm edge deviates from a further, uncorrected circumferential contour by a correction magnitude.

14. The projection exposure apparatus according to claim 11, wherein the correction diaphragm has a continuous correction profile along an entire diaphragm edge.

15. The projection exposure apparatus according to claim 14, wherein the correction diaphragm deviates from an uncorrected circumferential contour continuously by a correction magnitude along a diaphragm edge.

16. The projection exposure apparatus according to claim 11, wherein the correction diaphragm has a diaphragm edge that is adjustable in its circumferential contour at least in one correction section.

17. The projection exposure apparatus according to claim 11, wherein the correction diaphragm has a single central passage opening delimited by precisely one diaphragm edge.

18. The projection exposure apparatus according to claim 11, wherein the correction diaphragm has a ring-shaped passage opening delimited by an inner diaphragm edge and an outer diaphragm edge.

19. The projection exposure apparatus according to claim 11, wherein the correction diaphragm has a plurality of passage openings delimited by an outer diaphragm edge.

20. An optical unit, comprising:
a pupil facet mirror; and
a correction diaphragm having a diaphragm edge configured to partially shade illumination and imaging light so that an influence of a distortion aberration, arising as a result of reflection of illumination and imaging light at components of an imaging optical assembly for beam guiding of illumination and imaging light into an object field, on an illumination angle distribution of the illumination of the object field is at least partly compensated for,
wherein the optical unit is an illumination optical unit configured to be used in a projection exposure apparatus for microlithography.

21-24. (canceled)
